(19) United States
(12) Patent Application Publication
(10) Pub. No.: US 2009/0296578 A1
(43) Pub. Date: Dec. 3, 2009

(54) Optimal path selection for media content delivery

(76) Inventors: Marc R. Bernard, Miramar, FL (US); Douglas A. Atkinson, Ashburn, VA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/156,636

(22) Filed: Jun. 3, 2008

(51) Int. Cl. H04L 12/26

(52) U.S. Cl. 370/231

(57) ABSTRACT

Networks continually change in terms of physical, logical, and traffic loading. Determining efficient traffic flow from a content server to a subscriber is a difficult task, and slow network delivery can cause a subscriber to be dissatisfied with a service provider. A method or corresponding apparatus according to an example embodiment of the present invention selects the best physical or logical path via which devices should forward media content to end-user devices through multicast selection techniques, optionally in request or delivery directions, or both. The multicast selection allows devices to send streams over the most efficient channel detected in the network based on a criterion, such as latency. Upstream request multicast selection provides an ability to send requests faster, by sending them over multiple channels, and downstream multicast selection allows streams to be delivered faster in the downstream direction. Ultimately, shorter request times or faster delivery speed increases customer satisfaction.

### BACKGROUND OF THE INVENTION

Networks traditionally have been designed to support connectivity based on best-effort routing of network traffic. However, recent factors, such as continuous growth in both commercial and public network traffic content, increase in number of locations in which that content may be accessed, increase in quality of the content and devices available for viewing it, such as high-definition television (HDTV), as well as an increased number of formats and technologies that may be used to deliver such media content to end-user device has produced an increase in demand for improvements in the experience in viewing such content. As a result of this growth, there may be problems when requests for certain media streams are sent through a congested node or to a server that is overwhelmed streaming excess content and/or hosting several other customers. This is a particular concern for media streamed from specific websites or servers on wide area networks, such as the Internet. Particularly, networks with quality-of-service (QoS) requirements require new, QoS-oriented services. One issue in the design of such services is how to identify a feasible route that satisfies multiple constraints (e.g., bandwidth, delay, jitter).

### SUMMARY OF THE INVENTION

An embodiment of the present invention may be in a form of an apparatus, network employing the apparatus, or method for providing service to a network node. The embodiment may include multicasting a request for service toward at least one service node and supporting the service from the as least one service node.

An alternative embodiment includes a method of providing network service to a customer by enabling a network node to multicast a request for service toward at least one service node and to support the service from the at least one service node. The method further includes collecting a fee for enabling support of the multicasting and support of the service.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a diagram illustrating a logical point-to-multipoint, multicast upstream flow of requests from a node through a network toward at least one service node.

FIG. 1B is a diagram illustrating logical multicast of downstream flows of communications from at least one service node through a network toward a node.

FIG. 1C is a diagram illustrating an optimal path selected as a result of the logical point-to-multipoint, multicast, upstream flow of requests of FIG. 1A and the logical multicast of downstream flows of communications of FIG. 1B.

FIG. 2A is a block diagram illustrating an example embodiment apparatus for providing service to a network node.

FIG. 2B is a diagram illustrating a plurality of optimized paths carrying flows of streams from service nodes to Customer Premises Equipment (CPE) devices.

FIG. 3A is a flow diagram illustrating an example embodiment method for providing service to a network node.

FIG. 3B is a flow diagram illustrating an example method by which a request for service is multicast toward at least one service node.

FIG. 3C is a flow diagram illustrating an example method by which service from at least one service node may be supported.

FIG. 4 is a diagram illustrating a service model for a service provider to provide improved Quality of Service (QoS) to a customer and to generate revenue from the customer or a third party through sale of the improved QoS.

### DETAILED DESCRIPTION OF THE INVENTION

A description of example embodiments of the invention follows.

A method and corresponding apparatus may be used to select the best physical or logical path via which upstream nodes should forward media content to downstream nodes. Such selection allows nodes to send streams over the most efficient channel detected in a network based on a criterion, such as latency, to provide service to a network node. The selection can be made by multicasting a request for service toward at least one service node and supporting the service from the as least one service node. The request may be multicast over logical or physical links, with the request optionally formatted to travel multiple ones of the logical or physical links. The request may be multicast by multicasting a first received multicast signal of the request and ignoring later received multicast signals of the request. Identities of channels via which requests are received may be stored, and signals associated with the service may be transmitted via channels corresponding to the identities. Multicasting the request may be performed at least one node selected from a group consisting of: customer premises equipment, access equipment, and core network equipment.

Further, media content may be detected on at least one logical or physical channel toward a node requesting the service, and a cancellation request may be sent toward at least one service node via logical or physical channel(s) on which the media content is not detected or detected but not accepted. After detecting media content, the media content may be terminated. Further, in sending the cancellation request, it may be determined whether the first media content meets an acceptance criteria, and, if the first media content is not consistent with the acceptance criteria, a second media content from a different logical or physical channel may be selected.

Moreover, the media content may be multicast to at least one logical or physical channel toward a node requesting the service. Ports associated with the at least one predetermined logical or physical channel may be configured, the at least one predetermined logical or physical channel may be learned based on channels via which the request is received, and the media content may be multicast to all known logical or physical channels. Detecting media content may include detecting a first received media content and sending a cancellation request towards service nodes from which media content is later received.

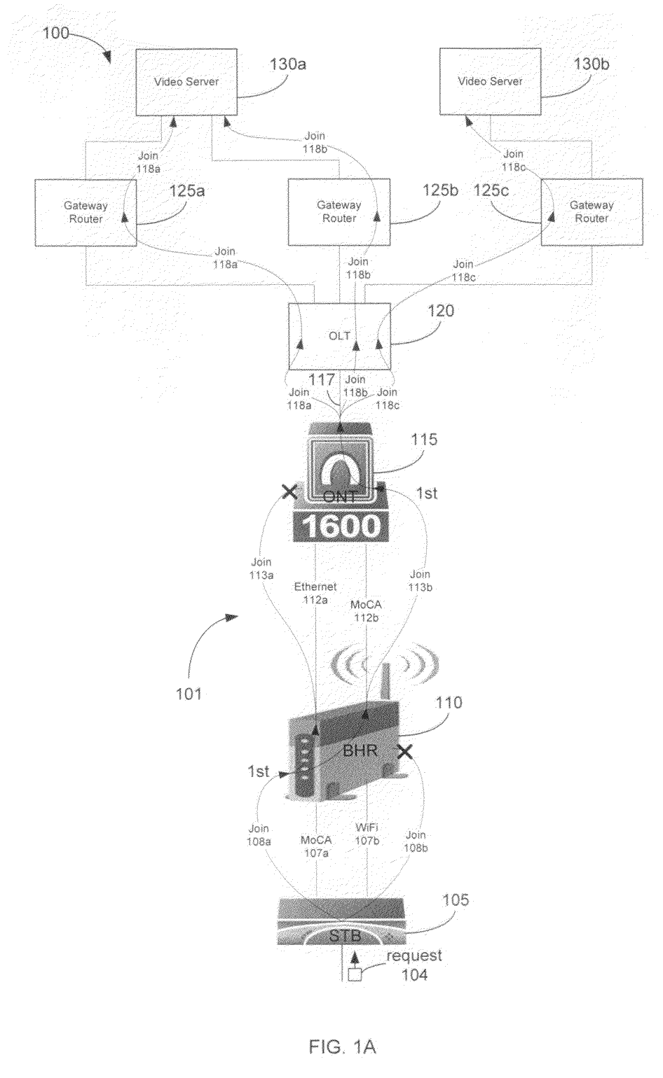

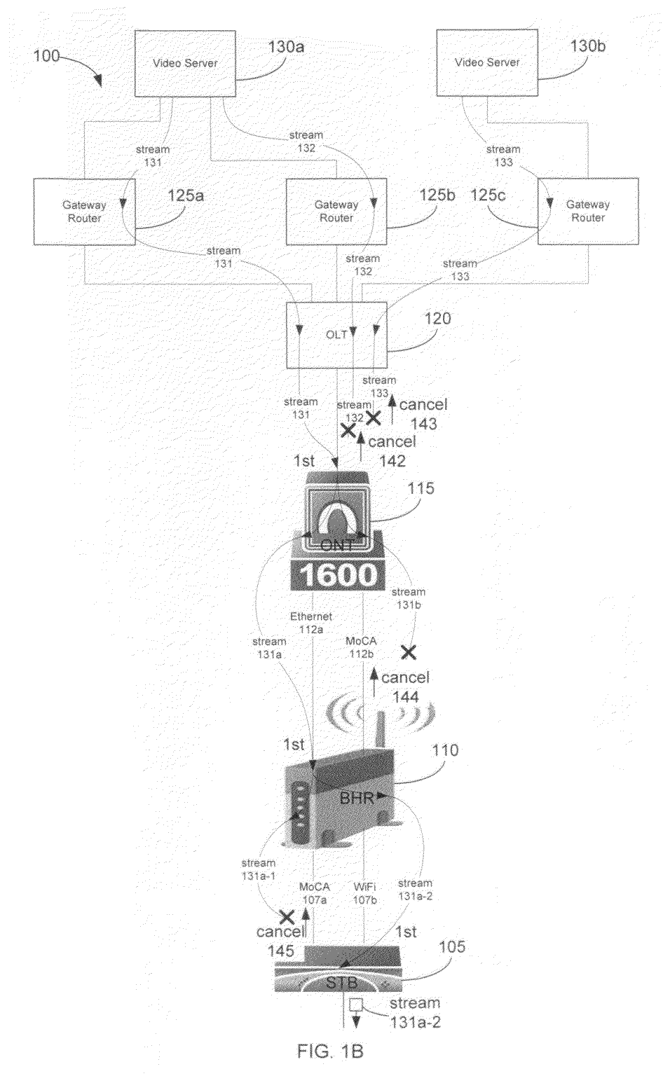

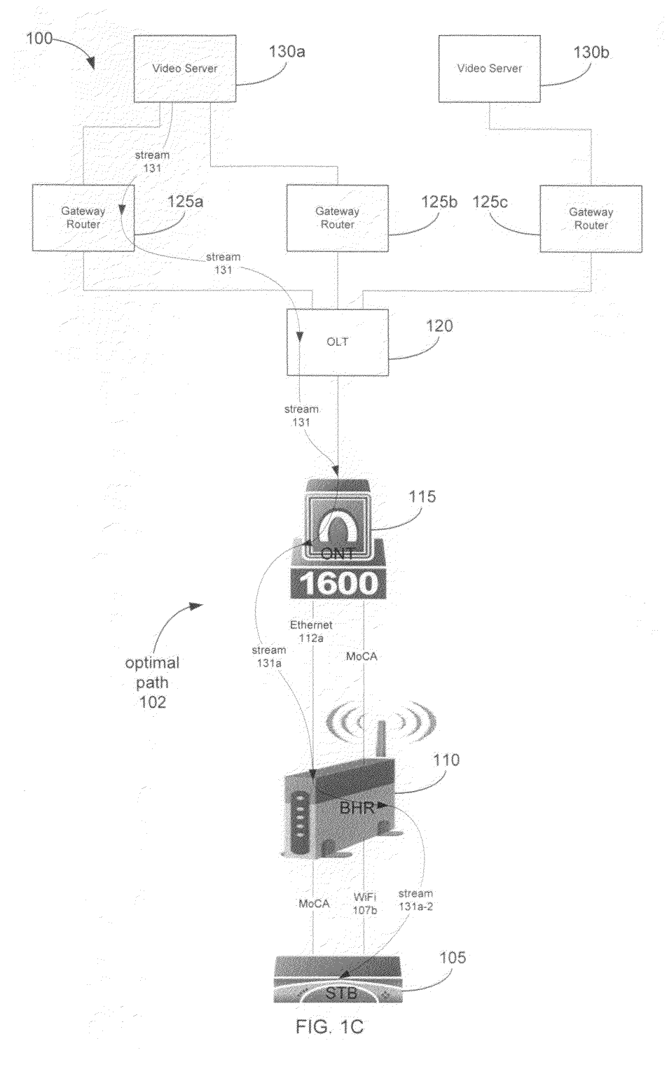

FIG. 1A is a diagram illustrating a logical point-to-multipoint, multicast upstream flow 101 of a request 104 through a network 100 from a node, such as a Set Top Box (STB) 105, toward at least one service node, such as Video Servers 130a, 130b. In this example embodiment, a node, which may be a Customary Premises Equipment (CPE) device, such as the STB 105, receives the request 104, processes the request 104, and multicasts Join requests 108a, 108b toward the Video Servers 130a, 130b over multiple physical or logical paths, such as Multimedia over Coax Alliance (MoCA) 107a and WiFi 107b.

The first Join request 108a to be received by the next upstream node, such as a Broadband Home Router (BHR) 110, is then re-multicast in a similar manner, with Join requests 113a, 113b being sent upstream over multiple physical or logical paths, such as Ethernet 112a and MoCA 112b. In one embodiment, Join requests later received by the BHR 110 (e.g., Join request 108b) are ignored by the BHR 110. Similarly, in one embodiment, only the first Join request 113b received by the next upstream node, such as an Optical Network Terminal (ONT) 115, is processed. All later received Join requests (e.g., Join request 113a) may be ignored.

The ONT 115 may format the first received Join request 113b into multiple formats 118a-118c to be transmitted over multiple channels 117. These channels 118a-118c may be different physical or logical channels, or may be multiple logical channels over a single physical channel 117. These Join requests 118a-118c are then routed upstream through Gateway Routers 125a-125c to the Video Servers 130a, 130b.

FIG. 1B is a diagram illustrating flows 131-133 of downstream communications from at least one service node 130a, 130b through a network 100 toward a node 105. Upon receiving the Join requests (e.g., Join requests 118a-118c of FIG. 1A), Video Servers 130a, 130b send streams 131, 132, 133 downstream through Gateway Routers 125a-125c and an Optical Line Terminal (OLT) 120 toward the STB 105. After receiving a stream that meets selection criteria, such as a first stream 131 to reach the ONT 115 or any other channel characteristic(s), such as latency or jitter, the ONT 115 sends Cancel requests 142, 143 upstream to all other channels for which Join requests were sent (e.g., Join requests 118b, 118c of FIG. 1A) on which the media content is not detected or detected but not accepted.

The ONT 115 then reformats the stream 131 to be transmitted over each channel for which requests were previously received. For example, here, the streams 131a, 131b are sent downstream over Ethernet 112a and MoCA 112b, respectively, to the BHR 110. Similarly, after receiving a stream that meets selection criteria, such as a first stream 131a received by the BHR 110 or any other selection criteria, the BHR 110 sends a Cancel request 144 upstream to all other channels for which Join requests were sent (e.g., Join requests 113 of FIG. 1A) on which the media content is not detected or detected but not accepted. The stream 131a is then formatted to be transmitted over each channel for which requests were received by the BHR 110. Here, the first stream 131a is reformatted to be transmitted as streams 131a-1, 131a-2 over MoCA 107a and WiFi 107b, respectively. As soon as the STB 105 receives a first stream 131a-2, it sends a Cancel request 145 over all other channels for which Join requests were sent, such as MoCA 107a, on which the media content is not detected or detected but not accepted, and processes the first received stream 131a-2.

FIG. 1C is a diagram illustrating an optimal path 102 selected as a result of the logical point-to-multipoint, multicast upstream flow of requests of FIG. 1A and the logical multicast of downstream flows of communications of FIG. 1B. In this example embodiment, the optimal path 102 includes a stream 131 from a Video Server 130a through a Gateway Router 125a and an OLT 120 to an ONT 115. The optimal path 101 then continues, including stream 131a over Ethernet 112a to a BHR 110, with the optimal path 101 concluding with stream 131a-2 over WiFi 107b to a STB 105. In general, at any point in time, any channel can be streaming content toward the CPE device, such as STB 105, based on network conditions such as congestion, latency, and server or other hardware problems. Such optimal path selection enables a service provider to deliver content over the network 100 to a user employing the CPE device in the most reliable and fastest possible way with the least latency.

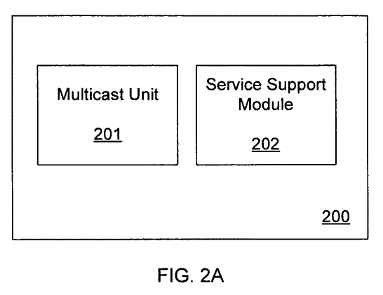

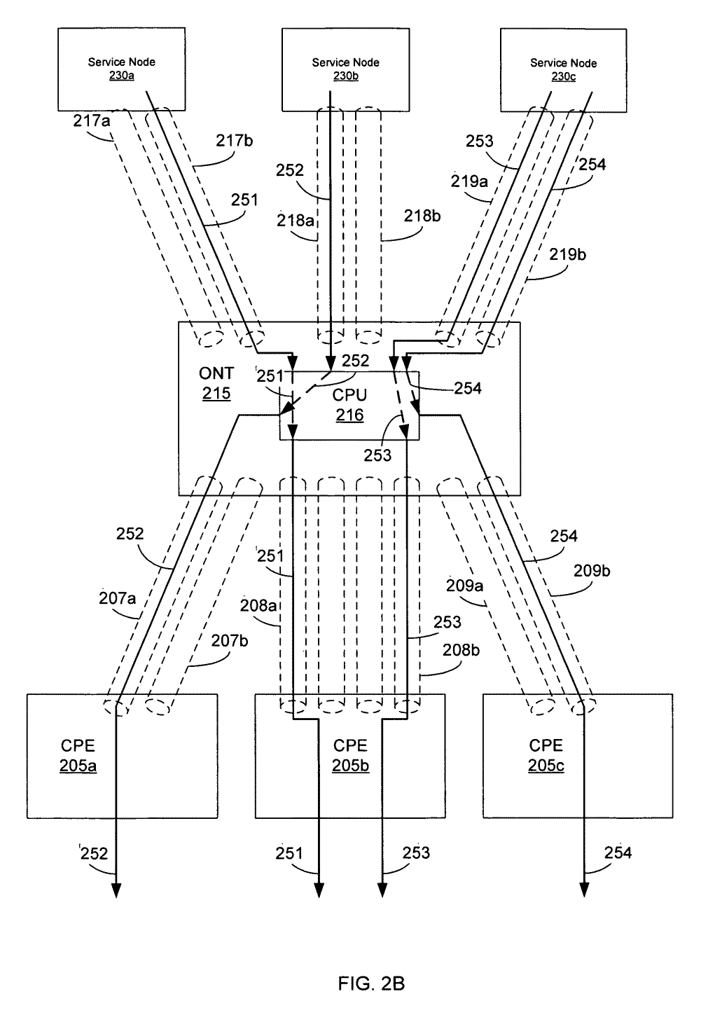

FIG. 2A is a block diagram illustrating an example embodiment apparatus 200 for providing service to a network node. The apparatus includes a multicast unit 201 configured to multicast a request for service toward at least one service node and a service support module 202 configured to support the service from the at least one service node.

FIG. 2B is a diagram illustrating a plurality of optimized paths carrying flows of streams 251, 252, 253, 254 from service nodes 230a-230c to CPE devices 205a-205c. As illustrated, data streams from the upstream service nodes 230a-230c over physical or logical paths 217-219 toward an ONT 215. When a stream 251-254 reaches the ONT 215, a central processing unit (CPU) directs the stream over its respective physical or logical path 207-209 from the ONT 215 to CPE devices 205a-205c. Thus, for example, a first stream 251 flows from a first service node 230a over a path 217b to the ONT 215, and from the ONT 215 over a path 208a to a first CPE device 205b. A second stream 252 flows from a second service node 230b over a path 218a to the ONT 215, and from the ONT 215 over a path 207a to a second CPE device 205a. A third stream 253 flows from a third service node 230c over a path 219a to the ONT 215, and from the ONT 215 over a path 208d to CPE the first CPE device 205b. A fourth stream 254 flows from the third service node 230c over a path 219b to the ONT 215 and from the ONT 215 over a path 209b to a third CPE device 205c.

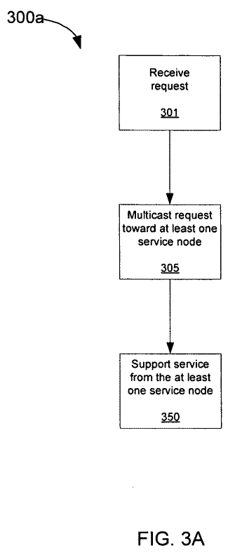

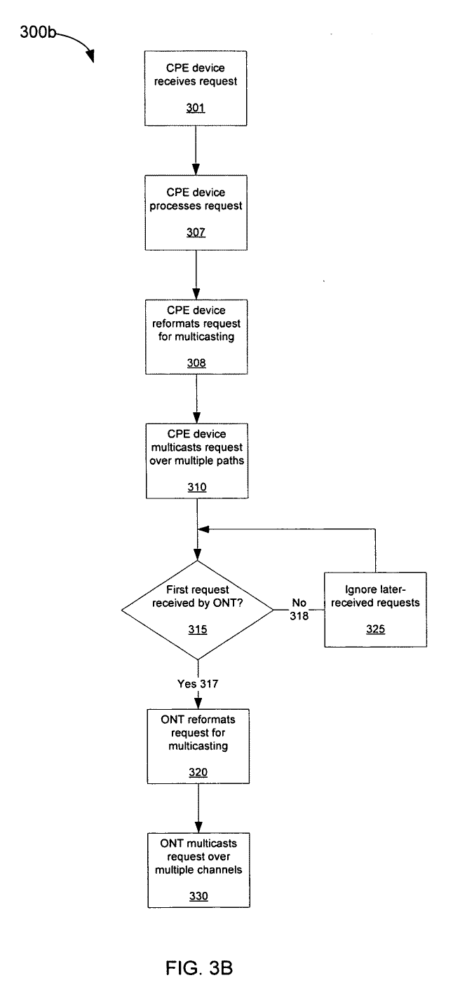

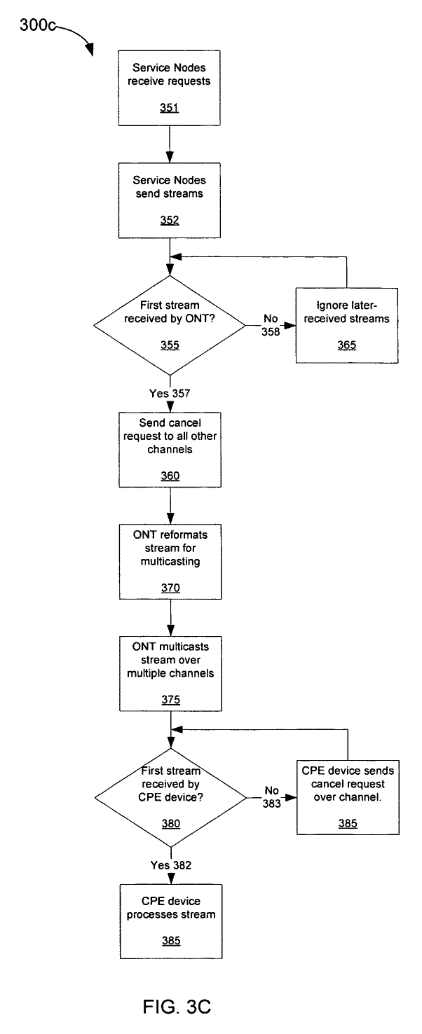

FIG. 3A is a flow diagram 300a illustrating an example embodiment method for providing service to a network node. After receiving a request 301, the request is multicast 305 toward at least one service node. Service from the at least one service node is then supported 350.

FIG. 3B is a flow diagram 300b illustrating an example method by which a request for service is multicast toward at least one service node. First, a CPE device receives the Join request 301, and processes 307 the request. The CPE device then reformats 308 the Join request for multicasting, and multicasts 310 the Join request over multiple paths. When an ONT receives a Join request, it is determined 315 whether it is the first Join request received by the ONT. If it is the first Join request 317, the ONT reformats 320 the Join request for multicasting, and multicasts 330 the Join request over multiple channels. However, if it is not the first Join request received by the ONT 318, the later received Join request is ignored 325.

FIG. 3C is a flow diagram 300c illustrating an example method by which service from at least one service node may be supported. First, the at least one service node receives the Join request 351, as multicast and described with reference to FIG. 3B. In response to the Join request, the at least one service node sends streams 352 to the network node. When a stream is received by the ONT, it is determined 355 whether it is the first stream received. If it is the first stream received 357, the ONT sends Cancel requests to all other channels 360 for which Join requests were multicast. All later received streams 358 are ignored 365 by the ONT. The ONT then reformats 370 the first received stream for multicasting and multicasts 375 the stream over multiple channels. Similarly, it is determined 380 whether streams received by the CPE device are the first stream. If a stream is the first stream received 382, the CPE device processes 385 the stream. If the stream is not the first stream received 383, then the CPE device sends Cancel requests 385 over all other channels for which Join requests were transmitted.

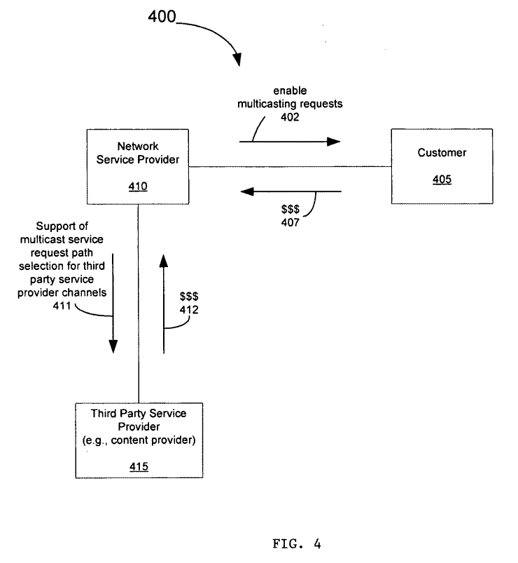

FIG. 4 is a diagram illustrating a service model 400 for a service provider 410 to enable improved Quality of Service (QoS) to a customer 402 and to generate revenue from the customer 405 or a third party service provider 415 through sale of the enablement of the improved QoS. In this example embodiment, revenue may be generated by a service provider 410 by enabling a network node 402, such as a customer 405 node, to support multicasting of a request for service toward at least one service node and to support the service from the at least one service node. In exchange for improved QoS experienced by the customer 405 via the enabling of the support of the multicasting and the support of the service, the customer 405 pays a first sum of money 407 to the service provider.

Alternatively, a third party service provider 415 may pay a second sum of money 412 to the service provider 410. In this example embodiment, the third party service provider 415, such as a cable network or premium Internet content provider, may want the customer 405 to experience improved QoS when viewing content provided by the third party service provider 415 in order to, for example, bolster the third party service provider's 415 brand. Therefore, the third party service provider may pay this second sum of money 412 to the service provider 410 so that content provided by the third party service provider 415 over a service provided by the service provider 410 is delivered to the customer 405 at a higher QoS than other content provided to the customer 405 by other third party service providers, for example, or by the third party service provider 415 without the multicast path selection 411.

Additionally, such improved QoS may be used by the service provider 410 to guarantee service level agreements (SLAs) with other providers. A service may include media content over the Internet. Moreover, the fee may be collected on a subscription service fee basis, a per-sub network basis, a per-network node basis, a per-service provider basis, and a per-third party content provider basis. The service may include content available exclusively through at least one of the third party content providers.

It should be noted that requests and data streams may be communicated over physical layers, logical layers, or a combination of both physical and logical layers. Logical channels may include Virtual Local Area Networks (VLANs), Ethernet frames, Multiprotocol Label Switching (MPLS), Asynchronous Transfer Mode (ATM), Virtual Channel Connection (VCC), Gigabit Passive Optical Network (GPON) Emulation Mode (GEM) Flow, Internet Protocol (IP) addresses, Media Access Control (MAC) Address, and Power-On Built-In-Test (P-BIT). Further, physical channels may include category 5 (CAT 5) cable, optical fiber, coaxial cable (COAX), wireless, ultra-wide band (UWB), twisted pair (TP), and electrical distribution system.

Requests may be transmitted by one or more of Ethernet, MoCA, Home Phone Line Networking Alliance (HPNA), Power Line, 802.1x/WiFi, Wi-Max, Bluetooth, Femtocell, Radio Frequency (RF), Overlay and RF Return Path, Passive Optical Network (PON) Data Over Cable Service Interface Specification (DOCSIS) and Example Digital Subscriber Line (xDSL). The data streams may include media content, such as, Windows Media, Moving Picture Experts Group (MPEG) 1/2/3/4, Analog Quaudrature Amplitude Modulation (QAM) Channels, Video On Demand (VOD), Internet Group Management Protocol (IGMP), Multicast and Unicast.

While this invention has been particularly shown and described with references to example embodiments thereof, it will be understood by those skilled in the art that various changes in form and details may be made therein without departing from the scope of the invention encompassed by the appended claims.

Implementations of flow diagrams illustrating example embodiments may be implemented in a form of hardware, firmware, software, and combinations thereof. If implemented in software, the software may be any suitable language, stored on a computer-readable medium, and be loaded and executed by a processor. The processor can be any general or application-specific processor that can execute the software in a manner consistent with the principles of the present invention, as claimed and illustrated by the example embodiments presented herein.

What is claimed is:

1. A method for providing service to a network node, the method comprising:
multicasting a request for service toward at least one service node; and
supporting the service from the at least one service node.

2. The method of claim 1 wherein multicasting the request for service further includes multicasting the request over logical or physical links.

3. The method of claim 2 wherein multicasting the request over logical or physical links further includes formatting signals with the request to travel multiple ones of the logical or physical links.

4. The method of claim 1 wherein multicasting the request includes multicasting a first received multicast signal of the request and ignoring later-received multicast signals of the request.

5. The method of claim 1 wherein multicasting the request includes storing identities of channels via which requests are received and wherein supporting the service includes transmitting signals associated with the service via channels corresponding to the identities.

6. The method of claim 1 wherein multicasting the request is performed at least one node selected from a group consisting of: customer premises equipment, access equipment, and core network equipment.

7. The method of claim 1 wherein supporting the service includes:
detecting media content on at least one logical or physical channel toward a node requesting the service; and
sending a cancellation request toward at least one service node via logical or physical channels on which the media content is not detected or detected but not accepted.

8. The method of claim 7 wherein the detecting media content includes terminating the media content.

9. The method of claim 7 wherein sending the cancellation request includes:
determining whether the first media content meets an acceptance criteria; and
selecting a second media content from a different logical or physical channel if the first media content is not consistent with the acceptance criteria.

10. The method of claim 7 further comprising multicasting the media content to at least one predetermined logical or physical channel toward a node requesting the service.

11. The method of claim 10 further comprising:
configuring ports associated with the at least one predetermined logical or physical channel;
learning the at least one predetermined logical or physical channel based on channels via which the request is received; and
multicasting the media content to all known logical or physical channels on the channels via which the request is received.

12. The method of claim 7 wherein detecting media content includes:
detecting a first received media content; and
sending a cancellation request toward service nodes from which media content is later received.

13. An apparatus for providing service to a network node, the apparatus comprising:
a multicast unit configured to multicast a request for service toward at least one service node; and
a service support module configured to support the service from the at least one service node.

14. The apparatus of claim 13 wherein the multicast unit is further configured to multicast the request over logical or physical links.

15. The apparatus of claim 14 wherein the multicast unit is further configured to format signals with the request to travel multiple ones of the logical or physical links.

16. The apparatus of claim 13 wherein the multicast unit is further configured to multicast a first received multicast signal of the request and ignore later-received multicast signals of the request.

17. The apparatus of claim 13 further comprising:
memory configured to store identities of channels via which requests are received; and
a transmitter configured to transmit signals associated with the service via channels corresponding to the identities.

18. The apparatus of claim 13 wherein the multicast unit is in at least one node selected from a group consisting of: customer premises equipment, access equipment, and core network equipment.

19. The apparatus of claim 13 further comprising:
a sensing unit configured to detect media content on at least one logical or physical channel toward a node requesting the service; and
a cancellation unit configured to send a cancellation request toward at least one service node via logical or physical channels on which the media content is not detected or detected but not accepted.

20. The apparatus of claim 19 further comprising a termination unit configured to terminate the media content.

21. The apparatus of claim 19 further comprising a comparator configured to determine whether the first media content meets an acceptance criteria, and wherein the service support module is further configured to select a second media content detected by the sensing unit from a different logical or physical channel if the first media content is not consistent with the acceptance criteria.

22. The apparatus of claim 19 wherein the multicast unit is further configured to multicast the media content to at least one predetermined logical or physical channel toward a node requesting the service.

23. The apparatus of claim 22 further comprising a manager configured to configure ports associated with the at least one predetermined logical or physical channel, wherein the service support module is further configured to learn the at least one predetermined logical or physical channels based on channels via which the request is received, and wherein the multicast unit is further configured to multicast the media content to all known logical or physical channels.

24. The apparatus of claim 19 wherein the sensing unit is further configured to detect a first received media content and wherein the cancellation unit is further configured to send a cancellation request toward service nodes from which media content is later received.

25. A network comprising:
a network node configured to generate a request for service;
at least one service node configured to, in response to the request for service, provide service to the network node; and
an intermediate network node configured to provide service to the network node by multicasting the request for service from the network node toward the at least one service node and support the service from the at least one service node.

26. A method of providing network service to a customer, the method comprising:
enabling a network node to support multicasting of a request for service toward at least one service node and to support the service from the at least one service node; and
collecting a fee in return for enabling the support of the multicasting and the support of the service.

27. The method of claim 26 wherein collecting the fee for enabling the support of the multicasting and the support of the service includes collecting the fee on at least one basis selected from a group consisting of: a subscription service fee basis, per-subnetwork basis, per-network node basis, per-service provider basis, per-third party content provider basis

28. The method of claim 27 wherein enabling the support of the multicasting and the support of the service includes supporting multicasting of a request for a service available exclusively through at least one of the third party content providers and supporting the exclusive service.
